(19) United States
(12) Patent Application Publication
(10) Pub. No.: US 2026/0189842 A1
(43) Pub. Date: Jul. 2, 2026

(54) EAR-CLIP WIRELESS HEADPHONE

(71) Applicant: Cosonic Intelligent Technologies Co., Ltd., Dongguan (CN)

(72) Inventors: Dengxu Cao, Dongguan (CN); Junbo Luo, Dongguan (CN); Xujian Luo, Dongguan (CN)

(21) Appl. No.: 19/288,957

(22) Filed: Aug. 1, 2025

(30) Foreign Application Priority Data
Dec. 26, 2024 (CN) 202411934928.7

(51) Int. Cl. H04R 1/10; H04R 1/06

(52) U.S. Cl. CPC H04R 1/105; H04R 1/06; H04R 1/1025; H04R 1/1066; H04R 2420/07

(57) ABSTRACT

An ear-clip wireless headphone is provided. The ear-clip wireless headphone includes a first headphone head, a second headphone head, and a bridge part. The bridge part is connected between the first headphone head and the second headphone head. The first headphone head is provided with a first airbag, the second headphone head is provided with a second airbag; and the first airbag and the second airbag are disposed opposite to each other. By disposing the airbags on opposite sides of the first headphone head and the second headphone head, whether the bridge part is made of hard material or flexible material, an additional buffer space exists on a surface of the ear-clip wireless headphone contacting with an ear of a user when the ear-clip wireless headphone is worn, which not only ensures stable wearing of the headphone, but also makes a wearing action more convenient, thereby significantly improving wearing comfort.

### CROSS-REFERENCE TO RELATED APPLICATION

This application claims priority to Chinese Patent Application No. 202411934928.7, filed on Dec. 26, 2024, which is herein incorporated by reference in its entirety.

### TECHNICAL FIELD

The disclosure relates to the technical field of headphones, and more particularly to an ear-clip wireless headphone.

### BACKGROUND

With a vigorous development of smart wearable industry, a diversity of headphones has become more abundant, and demand of users for product differentiation is growing day by day. With a development of headphone products, a duration that a product can be used on a single charge is becoming longer and longer. Consequently, the demand of users for a product to be more convenient and comfortable to wear for a long time is also increasing.

An ear-clip headphone is fixed to an ear in a form of ear clip and can be worn for a long time without entering an ear canal, therefore ensuring awareness of environment and reducing bacterial growth in the ear canal.

A “bridge” connection between waists of front and rear modules of ear-clip headphone in the art can be roughly divided into two types: 1) hard material connection and 2) memory steel wire connection. The hard material connection is non-deformable or only slightly deformable and needs to be forcibly opened to be fixed to the ear when wearing, leading to poor user experience and difficulty in wearing. The memory steel wire has a defect that connection deformation recovery ability of the memory steel wire is weakened after long-term use, leading to a risk of not being easily reset. Considering the two types of “bridges” connection, thickness of ears varies among different individuals, resulting in some users experiencing either a loose or tight fit. Moreover, during use, surfaces of the front and rear modules of the ear-clip headphone contacting with the ear are hard surfaces without any buffer space, leading to poor wearing comfort.

A Chinese patent application No. CN202410256446.4 (corresponding to patent publication No. CN117857971A) discloses an ear-clip Bluetooth headphone, including a headphone head, an ear clip, an attaching mechanism, and a synchronization mechanism. An inner wall of the ear clip defines a placing groove, and an end of the ear clip facing away from the headphone head is fixedly connected to an ear back clip. The attaching mechanism is disposed on an inner side of the ear clip. The synchronization mechanism is disposed between the attaching mechanism and the ear clip. The ear-clip Bluetooth headphone achieves a consistent fitting effect for users with different auricle shapes by having an air cushion column expand to fill a gap between an airbag cushion and a user's auricle, thereby enhancing wearing stability. However, the ear-clip Bluetooth headphone is not equipped with the airbag cushion on the headphone head, so that a technical problem of the ear-clip headphone in the art cannot be solved.

### SUMMARY

A technical problem to be solved by the disclosure is to provide an ear-clip wireless headphone aiming at defects in the related art. The ear-clip wireless headphone is provided with airbags on opposite sides of a first headphone head and a second headphone head. In this way, whether a bridge part is made of hard material or flexible material, an additional buffer space exists on a surface of the ear-clip wireless headphone contacting with an ear of a user when the ear-clip wireless headphone is worn, which not only ensures stable wearing of the headphone, but also makes a wearing action more convenient, thereby significantly improving wearing comfort.

To solve aforementioned problem, the ear-clip wireless headphone provided by the disclosure includes the first headphone head, the second headphone head, and the bridge part. The bridge part is connected between the first headphone head and the second headphone head. The first headphone head is provided with a first airbag; the second headphone head is provided with a second airbag; and the first airbag and the second airbag are disposed opposite to each other.

In an embodiment, the first airbag and the second airbag each are configured to be a deformable airbag under pressure. The first headphone head includes a first shell part, and a side of the first shell part facing towards the second headphone head defines a first concave part. The first airbag is disposed on the first concave part. The second headphone head includes a second shell part, and a side of the second shell part facing towards the first headphone head defines a second concave part. The second airbag is disposed on the second concave part.

In an embodiment, an outer side surface of the first airbag is a curved surface, and the outer side surface of the first airbag is connected smoothly with an outer side surface of the first shell part. An outer side surface of the second airbag is a curved surface, and the outer side surface of the second airbag is connected smoothly with an outer side of the second shell part.

In an embodiment, the first airbag is integrally connected to the first shell part through a two shot molding method or an overmolding method. The second airbag is integrally connected to the second shell part through the two shot molding method or the overmolding method.

In an embodiment, the first airbag and the first concave part are mutually clamped and fixed into a whole; and the second airbag and the second concave part are mutually clamped and fixed into a whole.

In an embodiment, the ear-clip wireless headphone further includes a rotating shaft structure. The rotating shaft structure is disposed on a connection between the first headphone head and the bridge part, disposed on a connection between the second headphone head and the bridge part, or disposed on the bridge part.

In an embodiment, the rotating shaft structure is disposed on the connection between the first headphone head and the bridge part. The first headphone head is configured to rotate outward based on the rotating shaft structure to open. The rotating shaft structure includes first rotating shaft mounting parts disposed on the first headphone head, second rotating shaft mounting parts disposed on an end of the bridge part, a rotating shaft, and an elastic component. Each of the first rotating shaft mounting parts defines a first shaft hole. Each of the second rotating shaft mounting parts defines a second shaft hole. The rotating shaft is inserted into the first shaft hole and the second shaft hole. The elastic component is configured to apply an elastic force to the first headphone head, so that the first headphone head rotates inward to close and reset under the elastic force of the elastic component after rotating outward to open.

In an embodiment, the elastic component is a torsion spring, and the torsion spring includes a spiral part sleeved outside the rotating shaft. An end of the spiral part is connected to a first torsion bar. A first support part is disposed on the first headphone head. The first torsion bar is abutted against the first support part. Another end of the spiral part is connected to a second torsion bar. A second support part is disposed on an end of the bridge part. The second torsion bar is abutted against the second support part.

In an embodiment, the first headphone head includes the first shell part. The first rotating shaft mounting parts and the first support part are disposed on an upper end of the first shell part. The first rotating shaft mounting parts are two in quantity. The bridge part includes a lower bridge shell. The second rotating shaft mounting parts are disposed on an end of the lower bridge shell, and the second rotating shaft mounting parts are two in quantity. The two second rotating shaft mounting parts are disposed between the two first rotating shaft mounting parts. The second support part is connected to ends of the two second rotating shaft mounting parts. An end of the rotating shaft passes through the first shaft hole of one of the two first rotating shaft mounting parts and the second shaft hole of one of the two second rotating shaft mounting parts, and another end of the rotating shaft passes through the first shaft hole of another one of the two first rotating shaft mounting parts and the second shaft hole of another one of the two second rotating shaft mounting parts. The spiral part of the torsion spring is disposed between the two second rotating shaft mounting parts and sleeved outside a middle part of the rotating shaft.

In an embodiment, a first limiting part is disposed on the upper end of the first shell part. The first limiting part is matched with a lower side of an end of the lower bridge shell correspondingly. The first limiting part is abutted against the lower side of the end of the lower bridge shell when the first headphone head rotates inward to close and reset. One of the two second rotating shaft mounting parts is connected to a second limiting part. The second limiting part is matched with an inner wall of the upper end of the first shell part correspondingly. The second limiting part is abutted against the inner wall of the upper end of the first shell part when the first headphone head rotates outward to open.

In an embodiment, gasket rings each are disposed between one of the two first rotating shaft mounting parts and a corresponding one of the two second rotating shaft mounting parts. Each end of the rotating shaft movably passes through a corresponding one of the gasket rings.

In an embodiment, the first headphone head includes a first cover part. The first cover part and the first shell part are configured to cover each other. The first shell part is provided with a partition plate. The first cover part, the first shell part and the partition plate of the first shell part together enclose a first waterproof chamber. A speaker is disposed inside the first waterproof chamber. The rotating shaft structure is disposed outside the first waterproof chamber.

In an embodiment, the second headphone head includes the second shell part and a second cover part. The second shell part and the second cover part enclose a second waterproof chamber. A battery and an electronic controller or emitter are disposed inside the second waterproof chamber. The bridge part includes an upper bridge shell. The upper bridge shell and the lower bridge shell are configured to cover each other. A wire channel is defined between the upper bridge shell and the lower bridge shell. A wire passes through the wire channel. An end of the wire is connected to the speaker, and another end of the wire is connected to the electronic controller or emitter.

The disclosure has the following beneficial effects. Since the first headphone head is provided with the first airbag, the second headphone head is provided with the second airbag, and the first airbag and the second airbag are disposed opposite to each other, whether the bridge part is made of hard material or flexible material, the additional buffer space exists on a surface of each of the first airbag and the second airbag contacting with the ear of the user when the ear-clip wireless headphone is worn, which not only ensures stable wearing of the headphone, but also makes the wearing action more convenient, thereby significantly improving the wearing comfort. Both the first airbag and the second airbag can provide a larger included angle degree for an ear shell by means of collapse deformation, making it convenient for the user to wear, and allowing the user to wear with one hand, thereby solving a problem of difficulty in wearing with one hand in the related art. In addition, in an embodiment of the disclosure, the ear-clip wireless headphone further includes the rotating shaft structure. The opening and closing of the first shell part and the second shell part are achieved through rotation of the rotating shaft structure, thereby ensuring stable wearing of the headphone, making the wearing action more convenient, and allowing the user to more easily wear the ear-clip wireless headphone with one hand.

### BRIEF DESCRIPTION OF DRAWINGS

FIG. 1 illustrates a schematic overall structural diagram of an ear-clip wireless headphone according to an embodiment of the disclosure.

FIG. 2 illustrates a schematic overall structural diagram of a first airbag and a second airbag of the ear-clip wireless headphone in a collapsed deformation state after being compressed according to the embodiment of the disclosure.

FIG. 3 illustrates a schematic exploded structural view of the ear-clip wireless headphone from a first perspective according to the embodiment of the disclosure.

FIG. 4 illustrates a schematic exploded structural view of the ear-clip wireless headphone from a second perspective according to the embodiment of the disclosure.

FIG. 5 illustrates a longitudinal sectional structural diagram of a first headphone head and a bridge part according to the embodiment of the disclosure.

FIG. 6 illustrates a further schematic exploded structural view of a rotating shaft structure of the ear-clip wireless headphone according to the embodiment of the disclosure.

FIG. 7 illustrates a schematic structural diagram of a rotating shaft illustrated in FIG. 6 passing through second rotating shaft mounting parts.

### DETAILED DESCRIPTION OF EMBODIMENTS

Structural principles and working principles of the disclosure will be further described in detail with reference to attached drawings.

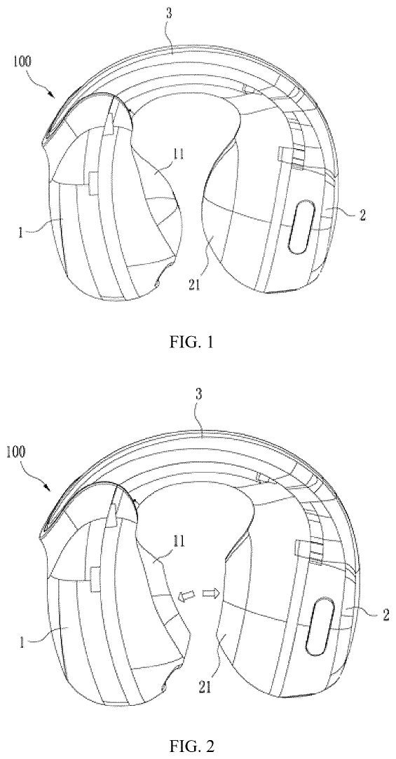

As illustrated in FIG. 1 through FIG. 5, an ear-clip wireless headphone provided by the disclosure includes a first headphone head 1, a second headphone head 2, and a bridge part 3. The bridge part 3 is connected between the first headphone head 1 and the second headphone head 2. The first headphone head 1 is provided with a first airbag 11; the second headphone head 2 is provided with a second airbag 21; and the first airbag 11 and the second airbag 21 are disposed opposite to each other. FIG. 2 illustrates a schematic overall structural diagram of the first airbag and the second airbag of the ear-clip wireless headphone in a collapsed deformation state after being compressed according to the embodiment of the disclosure. A pressure of the ear-clip wireless headphone on an ear is reduced or dispersed by collapse of the first airbag 11 and the second airbag 21.

Whether the bridge part 3 is made of hard material or flexible material, an additional buffer space exists on a surface of each of the first airbag 11 and the second airbag 12 contacting with the ear of a user when the ear-clip wireless headphone is worn, which not only ensures stable wearing of the headphone, but also makes a wearing action more convenient, thereby significantly improving wearing comfort. The first airbag 11 and the second airbag 12 can provide a larger included angle degree for the first headphone head 1 and the second headphone head 2 by means of collapse deformation, making it convenient for the user to wear, and allowing the user to wear with one hand, thereby solving a problem of difficulty in wearing with one hand in the related art. By applying a design of airbags to the ear-clip wireless headphone, the larger included angle degree is provided for the first headphone head 1 and the second headphone head 2 by means of collapse deformation, making it convenient for the user to wear. The first airbag 11 and the second airbag 21 are capable of rebounding and collapsing. After the collapsing, a gap between the first headphone head 1 and the second headphone head 2 becomes wider, making the ear-clip wireless headphone convenient to wear. When the ear of the user is thin, the gap between the first airbag 11 and the second airbag 21 becomes narrower, so that the ear-clip wireless headphone can be stably worn on the ear.

In an embodiment, the first airbag 11 and the second airbag 21 each are a deformable airbag under pressure. Each of the first airbag 11 and the second airbag 21 is one of a silicone airbag, a thermoplastic elastomer (TPE) airbag, and a thermoplastic polyurethane (TPU) elastomer airbag.

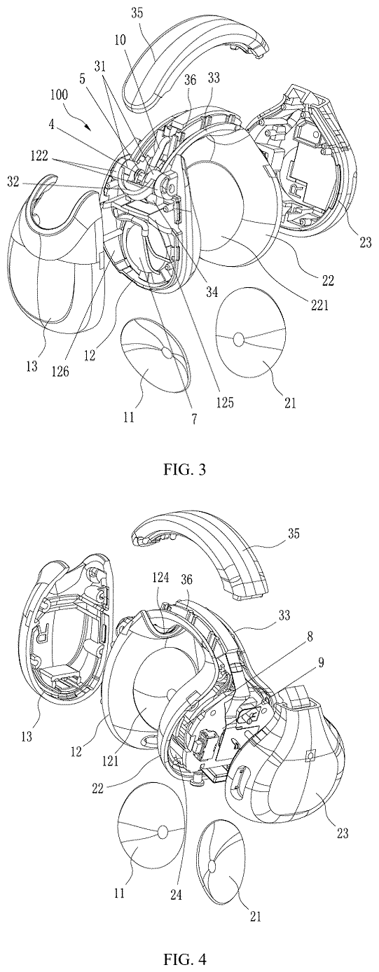

As illustrated in FIG. 3 through FIG. 5, the first headphone head 1 includes a first shell part 12, and a side of the first shell part 12 facing towards the second headphone head 2 defines a first concave part 121. The first airbag 11 is disposed on the first concave part 121. The second headphone head 2 includes a second shell part 22, and a side of the second shell part 22 facing towards the first headphone head 1 defines a second concave part 221. The second airbag 21 is disposed on the second concave part 221. An outer side surface of the first airbag 11 is a curved surface, and the outer side surface of the first airbag 11 is connected smoothly with an outer side surface of the first shell part 12. An outer side surface of the second airbag 21 is a curved surface, and the outer side surface of the second airbag 21 is connected smoothly with an outer side of the second shell part 22. In this way, the outer side surface of the first airbag 11 and the outer side surface of the first shell part 12 are visually integrated, and the outer side surface of the second airbag 21 and the outer side of the second shell part 22 are visually integrated, so that a visual effect is good.

The first airbag 11 and the second airbag 21 can be connected to the first headphone head 1 and the second headphone head 2, respectively, by two methods. A first method is to integrally connect the first airbag 11 to the first shell part 12 through a two shot molding method or an overmolding method, and to integrally connect the second airbag 21 to the second shell part 22 through the two shot molding method or the overmolding method. A second method is that the first airbag 11 and the first concave part 121 are mutually clamped and fixed into a whole; and the second airbag 21 and the second concave part 221 are mutually clamped and fixed into a whole.

As illustrated in FIG. 1 through FIG. 6, the ear-clip wireless headphone further includes a rotating shaft structure 100. The rotating shaft structure 100 is disposed on a connection between the first headphone head 1 and the bridge part 3, disposed on a connection between the second headphone head 2 and the bridge part 3, or disposed on the bridge part 3. The first shell part 12 and the second shell part 22 can rotate to be opened or closed to each other through rotation of the rotating shaft structure 100, thereby ensuring stable wearing of the headphone, making the wearing action more convenient, and allowing the user to more easily wear the ear-clip wireless headphone with one hand.

As illustrated in FIG. 1 through FIG. 6, in an embodiment, the rotating shaft structure 100 is disposed on the connection between the first headphone head 1 and the bridge part 3. The first headphone head 1 is configured to rotate outward based on the rotating shaft structure 100 to open. The rotating shaft structure 100 includes first rotating shaft mounting parts 122 disposed on the first headphone head 1, second rotating shaft mounting parts 31 disposed on an end of the bridge part 3, a rotating shaft 4, and an elastic component. Each of the first rotating shaft mounting parts 122 defines a first shaft hole 1221. Each of the second rotating shaft mounting parts 31 defines a second shaft hole 311. The rotating shaft 4 is inserted into the first shaft hole 1221 and the second shaft hole 311. The elastic component is configured to apply an elastic force to the first headphone head 1, so that the first headphone head 1 rotates inward to close and reset under the elastic force of the elastic component after rotating outward to open.

As illustrated in FIG. 4 through FIG. 6, the elastic component is a torsion spring 5, and the torsion spring 5 includes a spiral part 51 sleeved outside the rotating shaft 4. An end of the spiral part 51 is connected to a first torsion bar 52. A first support part 123 is disposed on the first headphone head 1. The first torsion bar 52 is abutted against the first support part 123. Another end of the spiral part 51 is connected to a second torsion bar 53. A second support part 32 is disposed on an end of the bridge part 3. The second torsion bar 53 is abutted against the second support part 32.

As illustrated in FIG. 4 through FIG. 6, the first headphone head 1 includes the first shell part 12. The first rotating shaft mounting parts 122 and the first support part 123 are disposed on an upper end of the first shell part 12. The first rotating shaft mounting parts 122 are two in quantity. The bridge part 3 includes a lower bridge shell 33. The second rotating shaft mounting parts 31 are disposed on an end of the lower bridge shell 33, and the second rotating shaft mounting parts 31 are two in quantity. The two second rotating shaft mounting parts 31 are disposed between the two first rotating shaft mounting parts 122. The second support part 32 is connected to ends of the two second rotating shaft mounting parts 31. An end of the rotating shaft 4 passes through the first shaft hole 1221 of one of the two first rotating shaft mounting parts 122 and the second shaft hole 311 of one of the two second rotating shaft mounting parts 31, and another end of the rotating shaft 4 passes through the first shaft hole 1221 of another one of the two first rotating shaft mounting parts 122 and the second shaft hole 311 of another one of the two second rotating shaft mounting parts 31. The spiral part 51 of the torsion spring 5 is disposed between the two second rotating shaft mounting parts 31 and sleeved outside a middle part of the rotating shaft 4.

As illustrated in FIG. 4 through FIG. 6, a first limiting part 124 is disposed on the upper end of the first shell part 12. The first limiting part 124 is matched with a lower side of an end of the lower bridge shell 33 correspondingly. When the first headphone head 1 rotates inward to close and reset, the first limiting part 124 is abutted against the lower side of the end of the lower bridge shell 33 to limit a terminal position of the first headphone head 1 rotating inward. One of the second rotating shaft mounting parts 31 is connected to a second limiting part 34. The second limiting part 34 is matched with an inner wall of the upper end of the first shell part 12 correspondingly. When the first headphone head rotates outward to open, the second limiting part 34 is abutted against the inner wall of the upper end of the first shell part 12 to limit a terminal position of the first headphone head 1 rotating outward.

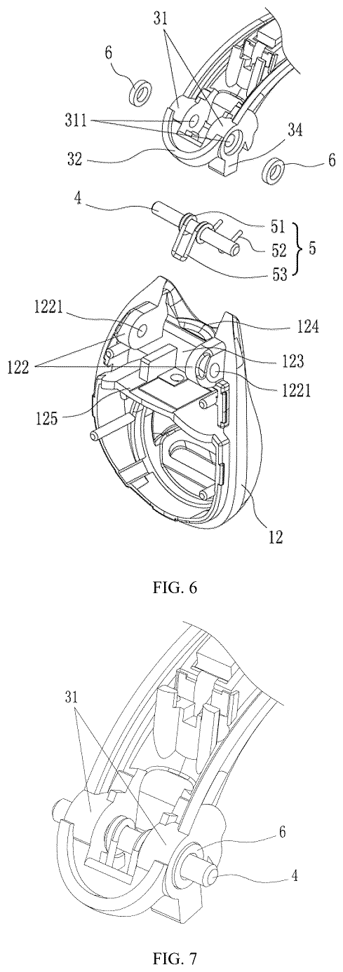

As illustrated in FIG. 6 and FIG. 7, gasket rings 6 each are disposed between one of the two first rotating shaft mounting parts 122 and a corresponding one of the two second rotating shaft mounting parts 31. Each end of the rotating shaft 4 movably passes through a corresponding one of the gasket rings 6. By disposing the gasket rings 6, direct contact friction between the first shaft mounting parts 122 and the second shaft mounting parts 31 can be avoided, thereby improving service life of the two first shaft mounting parts 122 and the two second shaft mounting parts 31.

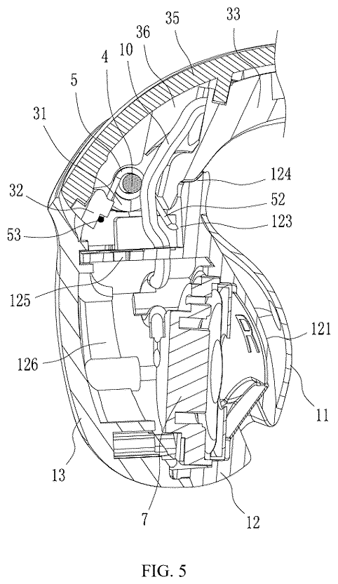

As illustrated in FIG. 4 and FIG. 5, the first headphone head 1 includes a first cover part 13. The first cover part 13 and the first shell part 12 are configured to cover each other. The first shell part 12 is provided with a partition plate 125. The first cover part 13, the first shell part 12, and the partition plate 125 of the first shell part 12 together enclose a first waterproof chamber 126. A speaker 7 is disposed inside the first waterproof chamber 126. The rotating shaft structure 100 is disposed outside the first waterproof chamber 126. By providing the partition plate 125, it can prevent external water vapor from entering the first headphone head 1 from a position of the rotating shaft structure 100.

As illustrated in FIG. 4 and FIG. 5, the second headphone head 2 includes the second shell part 22 and a second cover part 23. The second shell part 22 and the second cover part 23 enclose a second waterproof chamber 24. A battery 8 and an electronic controller or emitter 9 are disposed inside the second waterproof chamber 24. The bridge part 3 includes an upper bridge shell 35. The upper bridge shell 35 and the lower bridge shell 33 are configured to cover each other. A wire channel 36 is defined between the upper bridge shell 35 and the lower bridge shell 33. A wire 10 passes through the wire channel 36. An end of the wire 10 is connected to the speaker 7, and another end of the wire 10 is connected to the electronic controller or emitter 9.

Above contents are merely part of embodiments of the disclosure. All slight modifications, equivalent changes and improvements made to above embodiments based on technical solutions of the disclosure fall within a scope of protection of the disclosure.

What is claimed is:

1. An ear-clip wireless headphone, comprising a first headphone head, a second headphone head, and a bridge part; wherein the bridge part is connected between the first headphone head and the second headphone head; the first headphone head is provided with a first airbag; the second headphone head is provided with a second airbag; and the first airbag and the second airbag are disposed opposite to each other.

2. The ear-clip wireless headphone as claimed in claim 1, wherein the first airbag and the second airbag each are configured to be a deformable airbag under pressure; each of the first airbag and the second airbag is one selected from the group consisting of a silicone airbag, a thermoplastic elastomer (TPE) airbag, and a thermoplastic polyurethane (TPU) elastomer airbag.

3. The ear-clip wireless headphone as claimed in claim 1, wherein the first headphone head comprises a first shell part, a side of the first shell part facing towards the second headphone head defines a first concave part, the first airbag is disposed on the first concave part; and the second headphone head comprises a second shell part, a side of the second shell part facing towards the first headphone head defines a second concave part, and the second airbag is disposed on the second concave part.

4. The ear-clip wireless headphone as claimed in claim 3, wherein an outer side surface of the first airbag is a curved surface, and the outer side surface of the first airbag is connected smoothly with an outer side surface of the first shell part; and an outer side surface of the second airbag is a curved surface, and the outer side surface of the second airbag is connected smoothly with an outer side of the second shell part.

5. The ear-clip wireless headphone as claimed in claim 3, wherein the first airbag is integrally connected to the first shell part through a two shot molding method or an overmolding method, and the second airbag is integrally connected to the second shell part through the two shot molding method or the overmolding method.

6. The ear-clip wireless headphone as claimed in claim 3, wherein the first airbag and the first concave part are mutually clamped and fixed into a whole; and the second airbag and the second concave part are mutually clamped and fixed into a whole.

7. The ear-clip wireless headphone as claimed in claim 1, further comprising a rotating shaft structure, wherein the rotating shaft structure is disposed on a connection between the first headphone head and the bridge part, disposed on a connection between the second headphone head and the bridge part, or disposed on the bridge part.

8. The ear-clip wireless headphone as claimed in claim 7, wherein the rotating shaft structure is disposed on the connection between the first headphone head and the bridge part, the first headphone head is configured to rotate outward based on the rotating shaft structure to open; the rotating shaft structure comprises first rotating shaft mounting parts disposed on the first headphone head, second rotating shaft mounting parts disposed on an end of the bridge part, a rotating shaft and an elastic component; each of the first rotating shaft mounting parts defines a first shaft hole, each of the second rotating shaft mounting parts defines a second shaft hole, the rotating shaft is inserted into the first shaft hole and the second shaft hole; and the elastic component is configured to apply an elastic force to the first headphone head, so that the first headphone head rotates inward to close and reset under the elastic force of the elastic component after rotating outward to open.

9. The ear-clip wireless headphone as claimed in claim 8, wherein the elastic component is a torsion spring, and the torsion spring comprises a spiral part sleeved outside the rotating shaft; an end of the spiral part is connected to a first torsion bar, a first support part is disposed on the first headphone head, and the first torsion bar is abutted against the first support part; and another end of the spiral part is connected to a second torsion bar, a second support part is disposed on an end of the bridge part, and the second torsion bar is abutted against the second support part.

10. The ear-clip wireless headphone as claimed in claim 9, wherein the first headphone head comprises a first shell part, the first rotating shaft mounting parts and the first support part are disposed on an upper end of the first shell part, and the first rotating shaft mounting parts are two in quantity; the bridge part comprises a lower bridge shell, the second rotating shaft mounting parts are disposed on an end of the lower bridge shell, the second rotating shaft mounting parts are two in quantity, the two second rotating shaft mounting parts are disposed between the two first rotating shaft mounting parts, the second support part is connected to ends of the two second rotating shaft mounting parts; and an end of the rotating shaft passes through the first shaft hole of one of the two first rotating shaft mounting parts and the second shaft hole of one of the two second rotating shaft mounting parts, another end of the rotating shaft passes through the first shaft hole of another one of the two first rotating shaft mounting parts and the second shaft hole of another one of the two second rotating shaft mounting parts, and the spiral part of the torsion spring is disposed between the two second rotating shaft mounting parts, and sleeved outside a middle part of the rotating shaft.

11. The ear-clip wireless headphone as claimed in claim 10, wherein a first limiting part is disposed on the upper end of the first shell part, the first limiting part is matched with a lower side of an end of the lower bridge shell correspondingly, and the first limiting part is abutted against the lower side of the end of the lower bridge shell when the first headphone head rotates inward to close and reset; and one of the two second rotating shaft mounting parts is connected to a second limiting part, the second limiting part is matched with an inner wall of the upper end of the first shell part correspondingly, and the second limiting part is abutted against the inner wall of the upper end of the first shell part when the first headphone head is rotated outward to open.

12. The ear-clip wireless headphone as claimed in claim 10, wherein gasket rings each are disposed between one of the two first rotating shaft mounting parts and a corresponding one of the two second rotating shaft mounting parts, and each end of the rotating shaft movably passes through a corresponding one of the gasket rings.

13. The ear-clip wireless headphone as claimed in claim 10, wherein the first headphone head comprises a first cover part, the first cover part and the first shell part are configured to cover each other, the first shell part is provided with a partition plate, the first cover part, the first shell part and the partition plate of the first shell part together enclose a first waterproof chamber, a speaker is disposed inside the first waterproof chamber, and the rotating shaft structure is disposed outside the first waterproof chamber.

14. The ear-clip wireless headphone as claimed in claim 10, wherein the second headphone head comprises a second shell part and a second cover part, the second shell part and the second cover part enclose a second waterproof chamber, a battery and an electronic controller or emitter are disposed inside the second waterproof chamber; and the bridge part comprises an upper bridge shell, the upper bridge shell and the lower bridge shell are configured to cover each other, a wire channel is defined between the upper bridge shell and the lower bridge shell, a wire passes through the wire channel, an end of the wire is connected to a speaker, and another end of the wire is connected to the electronic controller or emitter.
